(19) United States
(12) Patent Application Publication
(10) Pub. No.: US 2026/0245402 A1
(43) Pub. Date: Aug. 20, 2026

(54) INFORMATION PROCESSING APPARATUS, INFORMATION PROCESSING METHOD, AND NON-TRANSITORY RECORDING MEDIUM

(71) Applicant: NEC Corporation, Tokyo (JP)

(72) Inventor: Chisato FUNAYAMA, Tokyo (JP)

(73) Assignee: NEC Corporation, Tokyo (JP)

(21) Appl. No.: 19/130,214

(22) PCT Filed: Nov. 22, 2022
(86) PCT No.: PCT/JP2022/043191

§ 371 Date: May 15, 2025

(51) Int. Cl. G06V 40/18; G06F 21/32; G06V 40/50

(52) U.S. Cl. CPC G06V 40/197; G06F 21/32; G06V 40/193; G06V 40/50; G06V 2201/07

(57) ABSTRACT

An information processing apparatus includes: an acquisition unit that acquires, from biometric information on a target included in an image, feature information indicating features of the biometric information; a determination unit that determines whether or not unauthorized use of the biometric information is possible, by using the feature information; and an output unit that outputs an alert in response to the determination by the determination unit that the unauthorized use is possible.

### TECHNICAL FIELD

This disclosure relates to technical fields of an information processing apparatus, an information processing system, an information processing method, and a recording medium.

### BACKGROUND ART

Patent Literature 1 describes a technology/technique in which there are provided: a camera for picking up an image of a user from an inside of an elevator car; an image transmitting part for transmitting image information to a display part, an ID receiving part for receiving preliminarily registered ID; a personal identifying part for preliminarily registering a plurality of pieces of personal information and for deciding whether or not the ID received from the ID receiving part is registered as the personal information corresponding to the ID; and a use recording part for storing use history information in the elevator car, wherein when the ID received by the ID receiving part is registered as the personal information corresponding to the ID, the personal identifying part stops the transmission of the picked-up image information, and records, in the use recording part, information indicating that the personal information registered in the personal identifying part is included.

Patent Literature 2 describes a personal authentication system including: an authentication information acquisition part acquiring information about a condition, in which predetermined processing is carried out on predetermined body features of a person, as authentication information for authentication determination in authentication of the person; a registration information acquisition part acquiring information about the condition after application of the predetermined processing to the predetermined body features, which are previously registered, of the person as registration information for authentication; and an authentication determination part determining authentication of the authentication information acquired by the authentication information acquisition part, based on the registration information acquired by the registration information acquisition part.

Patent Literature 3 describes an apparatus including: an image recognition means for recognizing a face image of a person by image processing of an image file; an image editing means for editing the face image of the image file into one from which the person is unidentifiable; and an attribute editing means for editing private identification information contained in the attribute information so that it is undecodable.

Patent Literature 4 describes a technology/technique of: acquiring a cutout region of an authenticated user; regarding the image of the acquired cutout region, acquiring a private region of the authenticated user and a private region of a person other than the authenticated user; acquiring an image processing rule; and determining an image processing method for each region within the cutout region according to the acquired image processing rule.

Patent Literature 5 describes a technology/technique of: storing a processed image obtained by processing a face image of a user, and a face image of the user; authenticating the user using the processed image and the face image before a position guiding service is provided; and specifying the user who receives the position guiding service by executing a check-up on the face image upon providing the position guiding service to the user when the authentication is successful.

### CITATION LIST

### Patent Literature

Patent Literature 1: JP2004-048519A
Patent Literature 2: JP2006-350886A
Patent Literature 3: JP2010-044625A
Patent Literature 4: International Publication No. WO2012/004907
Patent Literature 5: JP2020-204896A

### SUMMARY

It is an example object of this disclosure to provide an information processing apparatus, an information processing method, and a recording medium that are intended to improve the techniques/technologies disclosed in Citation List.

### Solution to Problem

An information processing apparatus according to an example aspect includes: an acquisition unit that acquires, from biometric information on a target included in an image, feature information indicating features of the biometric information; a determination unit that determines whether or not unauthorized use of the biometric information is possible, by using the feature information; and an output unit that outputs an alert in response to the determination by the determination unit that the unauthorized use is possible.

An information processing method according to an example aspect includes: acquiring, from biometric information on a target included in an image, feature information indicating features of the biometric information; determining whether or not unauthorized use of the biometric information is possible, by using the feature information; and outputting an alert in response to the determination that the unauthorized use is possible.

A recording medium according to an example aspect is a recording medium on which a computer program that allows a computer to execute an information processing method is recorded, the information processing method including: acquiring, from biometric information on a target included in an image, feature information indicating features of the biometric information; determining whether or not unauthorized use of the biometric information is possible, by using the feature information; and outputting an alert in response to the determination that the unauthorized use is possible.

### BRIEF DESCRIPTION OF DRAWINGS

FIG. 1 is a block diagram illustrating a configuration of an information processing apparatus in a first example embodiment.

FIG. 2 is a block diagram illustrating a configuration of an information processing apparatus in a second example embodiment.

FIG. 3 is a flowchart illustrating a flow of an information processing operation of the information processing apparatus in the second example embodiment.

FIG. 4 is a block diagram illustrating a configuration of an information processing apparatus in a third example embodiment.

FIG. 5 is a flowchart illustrating a flow of an information processing operation of the information processing apparatus in the third example embodiment.

FIG. 6 is a block diagram illustrating a configuration of an information processing apparatus in a fourth example embodiment.

FIG. 7 is a flowchart illustrating a flow of an information processing operation of the information processing apparatus in the fourth example embodiment.

FIG. 8 is a block diagram illustrating a configuration of an information processing apparatus in a fifth example embodiment.

FIG. 9 is a flowchart illustrating a flow of an information processing operation of the information processing apparatus in the fifth example embodiment.

FIG. 10 is a block diagram illustrating a configuration of an information processing apparatus in a sixth example embodiment.

FIG. 11 is a block diagram illustrating a configuration of an information processing apparatus in a seventh example embodiment.

FIG. 12 is a block diagram illustrating a configuration of an information processing apparatus in an eighth example embodiment.

FIG. 13 is a block diagram illustrating a configuration of an information processing apparatus in a ninth example embodiment.

FIG. 14 is a block diagram illustrating a configuration of an information processing apparatus in a tenth example embodiment.

FIG. 15 is a block diagram illustrating a configuration of an information processing apparatus in an eleventh example embodiment.

### DESCRIPTION OF EXAMPLE EMBODIMENTS

Hereinafter, with reference to the drawings, an information processing apparatus, an information processing method, and a recording medium according to example embodiments will be described.

### 1: First Example Embodiment

An information processing apparatus, an information processing method, and a recording medium according to a first example embodiment will be described. The following describes the information processing apparatus, the information processing method, and the recording medium according to the first example embodiment, by using an information processing apparatus A1 to which the information processing apparatus, the information processing method, and the recording medium according to the first example embodiment are applied.

### [1-1: Configuration of Information Processing Apparatus A1]

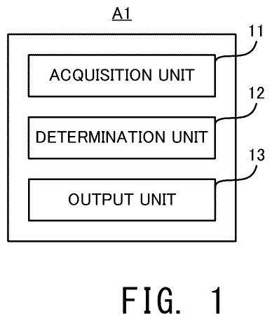

FIG. 1 is a block diagram illustrating a configuration of the information processing apparatus A1 in the first example embodiment. As illustrated in FIG. 1, the information processing apparatus A1 includes an acquisition unit 11, a determination unit 12, and an output unit 13.

The acquisition unit 11 acquires, from biometric information on a target included in an image, feature information indicating features of the biometric information. The determination unit 12 determines whether or not unauthorized use of the biometric information is possible, by using the feature information. The output unit 13 outputs an alert in a case where the determination unit 12 determines that the unauthorized use of the biometric information is possible.

### [1-2: Technical Effect of Information Processing Apparatus A1]

The information processing apparatus A1 in the first example embodiment outputs an alert in a case where the unauthorized use of the biometric information is possible, and it may therefore prevent the unauthorized use of the biometric information.

### 2: Second Example Embodiment

Next, an information processing apparatus, an information processing method, and a recording medium according to a second example embodiment will be described. The following describes the information processing apparatus, the information processing method, and the recording medium according to the second example embodiment, by using an information processing apparatus A2 to which the information processing apparatus, the information processing method, and the recording medium according to the second example embodiment are applied.

### [2-1: Configuration of Information Processing Apparatus A2]

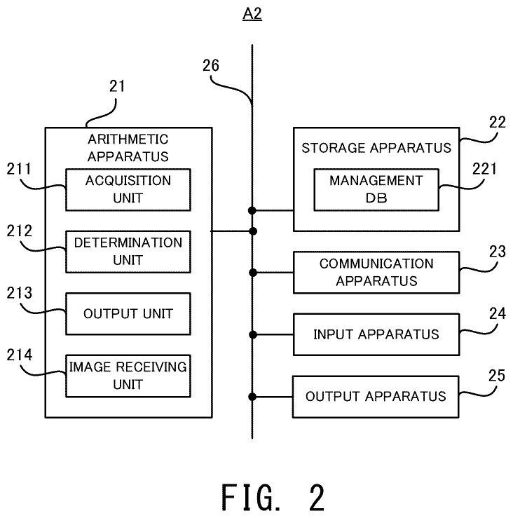

FIG. 2 is a block diagram illustrating a configuration of the information processing apparatus A2 in the second example embodiment. As illustrated in FIG. 2, the information processing apparatus A2 includes an arithmetic apparatus 21 and a storage apparatus 22. Furthermore, the information processing apparatus A2 may include a communication apparatus 23, an input apparatus 24, and an output apparatus 25. The information processing apparatus A2, however, may not include at least one of the communication apparatus 23, the input apparatus 24, and the output apparatus 25. The arithmetic apparatus 21, the storage apparatus 22, the communication apparatus 23, the input apparatus 24, and the output apparatus 25 may be connected via a data bus 26.

The arithmetic apparatus 21 includes, for example, at least one of a CPU (central processing unit), a GPU (graphics processing unit), and an FPGA (field programmable gate array). The arithmetic apparatus 21 reads a computer program. For example, the arithmetic apparatus 21 may read a computer program stored in the storage apparatus 22. For example, the arithmetic apparatus 21 may read a computer program stored in a computer-readable and non-transitory recording medium, by using a not-illustrated recording medium reading apparatus provided in the information processing apparatus A2 (e.g., the input apparatus 24 described later). The arithmetic apparatus 21 may acquire (in other words, download or read) a computer program from a not-illustrated apparatus disposed outside the information processing apparatus A2, via the communication apparatus 23 (or another communication apparatus). The arithmetic apparatus 21 executes the read computer program. Consequently, a logical functional block for performing an operation to be performed by the information processing apparatus A2 is realized in the arithmetic apparatus 21. That is, the arithmetic apparatus 21 is allowed to function as a controller for realizing the logical functional block for performing an operation (or, in other words, processing) to be performed by the information processing apparatus A2.

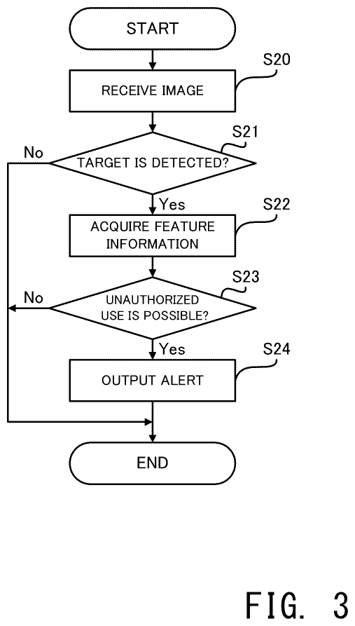

FIG. 2 illustrates an example of the logical functional block realized in the arithmetic apparatus 21 in order to perform an information processing operation. As illustrated in FIG. 2, an acquisition unit 211 that is a specific example of the “acquisition unit” described later in Supplementary Notes, a determination unit 212 that is a specific example of the “determination unit” described later in Supplementary Notes, an output unit 213 that is a specific example of the “output unit” described later in Supplementary Notes, and an image receiving unit 214 are realized in the arithmetic apparatus 21. However, the image receiving unit 214 may not be realized in the arithmetic apparatus 21. Details of operation of the acquisition unit 211, the determination unit 212, the output unit 213, and the image receiving unit 214 will be described later with reference to FIG. 3.

The storage apparatus 22 is configured to store desired data. For example, the storage apparatus 22 may temporarily store a computer program to be executed by the arithmetic apparatus 21. The storage apparatus 22 may temporarily store data that are temporarily used by the arithmetic apparatus 21 when the arithmetic apparatus 21 executes the computer program. The storage apparatus 22 may store data that are stored for a long time by the information processing apparatus A2. The storage apparatus 22 may include at least one of a random access memory (RAM), a read-only memory (ROM), a hard disk apparatus, a magneto-optical disk apparatus, a solid state drive (SSD), and a disk array apparatus. That is, the storage apparatus 22 may include anon-transitory recording medium. A management database 221, which will be described later, may be realized in the storage apparatus 22. The management database 221, however, may not be realized in the storage apparatus 22.

The communication apparatus 23 is configured to communicate with an apparatus external to the information processing apparatus A2 via a not-illustrated communication network. The communication apparatus 23 may be a communication interface based on standards such as Ethernet (registered trademark), Wi-Fi (registered trademark), Bluetooth (registered trademark), and USB (Universal Serial Bus).

The input apparatus 24 is an apparatus that receives an input of information to the information processing apparatus A2 from an outside of the information processing apparatus A2. For example, the input apparatus 24 may include an operating apparatus (e.g., at least one of a keyboard, a mouse, and a touch panel) that is operable by an operator of the information processing apparatus A2. For example, the input apparatus 24 may include a reading apparatus that is configured to read information recorded as data on a recording medium that is externally attachable to the information processing apparatus A2.

The output apparatus 25 is an apparatus that outputs information to the outside of the information processing apparatus A2. For example, the output apparatus 25 may output information as an image. That is, the output apparatus 25 may include a display apparatus (a so-called display) that is configured to display an image indicating the information that is desirably outputted. For example, the output apparatus 25 may output information as audio/sound. That is, the output apparatus 25 may include an audio apparatus (a so-called speaker) that is configured to output audio/sound. For example, the output apparatus 25 may output information onto a paper surface. That is, the output apparatus 25 may include a printing apparatus (a so-called printer) that is configured to print desired information on the paper surface.

### [2-2: Information Processing Operation Performed by Information Processing Apparatus A2]

With reference to FIG. 3, an information processing operation performed by the information processing apparatus A2 in the second example embodiment will be described. FIG. 3 is a flowchart illustrating a flow of the information processing operation performed by the information processing apparatus A2 in the second example embodiment.

As illustrated in FIG. 3, the image receiving unit 214 receives an image from the outside of the information processing apparatus A2 (step S20). In this example embodiment, the term “image” conceptually includes a still image and a moving image. The term “image” may refer to a still image, a moving image, or a part of frames included in a moving image. The image receiving unit 214 may receive an image provided by a provider, from the outside of the information processing apparatus A2. The provider may be considered to be a person who makes the image processable in the information processing apparatus A2.

The acquisition unit 211 detects whether the image includes a target person (step S21). The target person may be a user who uses a service provided by the information processing apparatus A2. The target person may be the same person as the provider.

The acquisition unit 211 acquires, from biometric information on the target person, feature information indicating features of the biometric information (step S22). The feature information may be a feature vector extracted from the biometric information. That is, the acquisition unit 211 may extract the feature vector from the biometric information on the target person.

The determination unit 212 performs a determination operation of determining whether or not unauthorized use of the biometric information is possible, by using the feature information (step S23). Here, the unauthorized use may include an impersonation/spoofing act in which another person is recognized as a person to be authorized, by using biometric information on the person to be authorized. The unauthorized use may also include an act of searching for the person to be authorized by matching using the biometric information, or the like, and leaking privacy such as where and what the person did.

The determination unit 212 may match the feature information with registration feature information that is registered in advance, and may make a determination based on a matching result. The registration feature information may be registered in the management database 221. The registration feature information may be registered in the management database 221 in association with information capable of identifying the target person.

When it is determined that unauthorized use is possible (the step S23: Yes), the output unit 213 outputs an alert (step S24). The output unit 213 may output the alert to at least one of the target person and the provider.

### [2-3: Technical Effect of Information Processing Apparatus A2]

The information processing apparatus A2 in the second example embodiment determines whether or not the unauthorized use is possible, based on a result of matching with the registration feature information registered in advance. It is therefore possible to accurately determine whether or not the biometric information included in the image is usable to identify the person to be authorized. When the information processing apparatus A2 determines that the unauthorized use is possible, at least one of the target person and the provider receives an alert. It is therefore possible to reduce/control the unauthorized use of the biometric information without the target person or provider realizing it.

### 3: Third Example Embodiment

Next, an information processing apparatus, an information processing method, and a recording medium according to a third example embodiment will be described. The following describes the information processing apparatus, the information processing method, and the recording medium according to the third example embodiment, by using an information processing apparatus A3 to which the information processing apparatus, the information processing method, and the recording medium according to the third example embodiment are applied.

### [3-1: Configuration of Information Processing Apparatus A3]

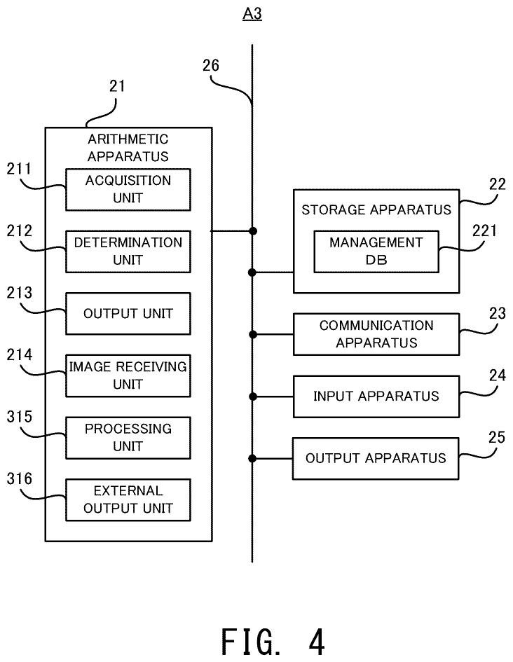

As illustrated in FIG. 4, the information processing apparatus A3 in the third example embodiment includes the arithmetic apparatus 21 and the storage apparatus 22, as in the information processing apparatus A2 in the second example embodiment. Furthermore, the information processing apparatus A3 in the third example embodiment may include the communication apparatus 23, the input apparatus 24, and the output apparatus 25, as in the information processing apparatus A2 in the second example embodiment. The information processing apparatus A3, however, may not include at least one of the communication apparatus 23, the input apparatus 24, and the output apparatus 25. The information processing apparatus A3 in the third example embodiment differs from the information processing apparatus A2 in the second example embodiment, in that the arithmetic apparatus 21 further includes a processing unit 315 and an external output unit 316. Other features of the information processing apparatus A3 may be the same as those of the information processing apparatus A2 in the second example embodiment. For this reason, a part differing from each of the example embodiments described above will be described in detail below, and a description of the other overlapping parts will be omitted as appropriate.

### [3-2: Information Processing Operation Performed by Information Processing Apparatus A3]

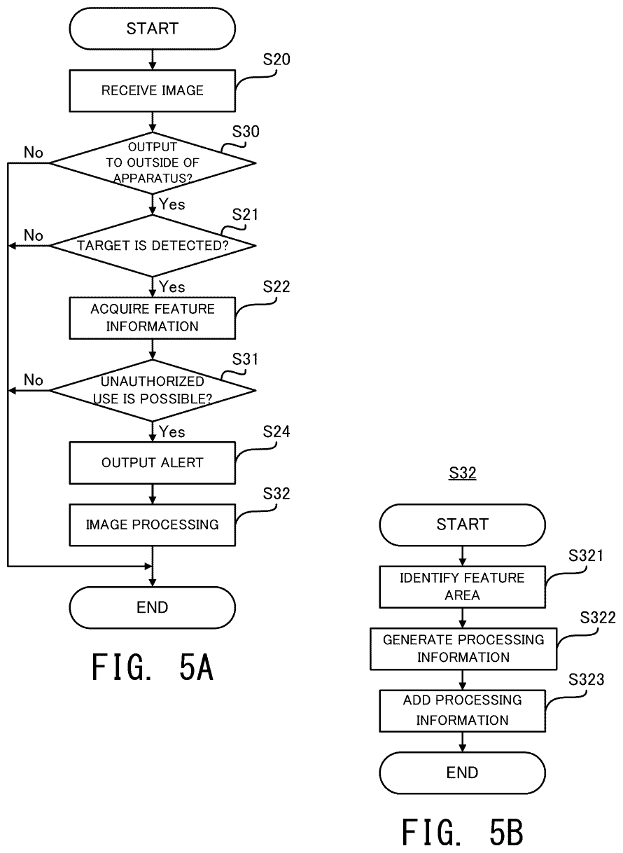

With reference to FIG. 5, an information processing operation performed by the information processing apparatus A3 in the third example embodiment will be described. FIG. 5 is a flowchart illustrating a flow of the information processing operation performed by the information processing apparatus A3 in the third example embodiment.

As illustrated in FIG. 5(a), when the image is received (step S20), the external output unit 316 determines whether or not to output the image to an outside of the information processing apparatus A3 (step S30). A case of outputting the image to the outside may include a case of making the image viewable on the Internet, for example. When the image is outputted to the outside of the information processing apparatus A3, the target person is detected (step S21), the feature information is acquired (step S22), and the determination unit 212 performs the determination operation (step S31). In this way, the determination operation by the determination unit 212 may be performed at least when the image is outputted to the outside of the information processing apparatus A3. When it is determined that the unauthorized use is possible (the step S31: Yes), an alert is outputted (step S24), and the processing unit 315 processes the image (step S32).

### [Step S32: Image Processing]

As illustrated in FIG. 5(b), the processing unit 315 identifies a feature area in the image from which the acquisition unit 211 acquires the feature information, for the biometric information that is determined to be usable for unauthorized purpose (step S321). The feature area may be an area corresponding to the biometric information. For example, in a case where the biometric information is an image including an iris, the feature area may be an iris area. The processing unit 315 generates processing information (step S322). The processing information generated by the processing unit 315 may be information that may prevent the unauthorized use of the biometric information. The processing information may be information that may prevent leakage of the biometric information. The processing information may be information that may prevent successful matching using the biometric information. The processing information may be information that may make biometric authentication difficult. A specific example of the processing information will be described in detail in another example embodiment. The processing unit 315 adds the processing information to the area corresponding to the feature area (step S323). The image in which the processing information is added by the processing unit 315 to the area corresponding to the feature area, will be sometimes referred to as a “processed image”.

The external output unit 316 outputs the processed image to the outside of the information processing apparatus A3. The external output unit 316 transmits, to a scheduled destination, the image to which the processing information is superimposed, instead of the image including the biometric information.

### [3-3: Technical Effect of Information Processing Apparatus A3]

The information processing apparatus A3 in the third example embodiment is configured to process the image, and it may therefore prevent its unauthorized use. The information processing apparatus A3 outputs the processed image to the outside of the information processing apparatus A3, and it may therefore prevent the unauthorized use in the outside of the information processing apparatus A3.

### 4: Fourth Example Embodiment

Next, an information processing apparatus, an information processing method, and a recording medium according to a fourth example embodiment will be described. The following describes the information processing apparatus, the information processing method, and the recording medium according to the fourth example embodiment, by using an information processing apparatus A4 to which the information processing apparatus, the information processing method, and the recording medium according to the fourth example embodiment are applied.

### [4-1: Configuration of Information Processing Apparatus A4]

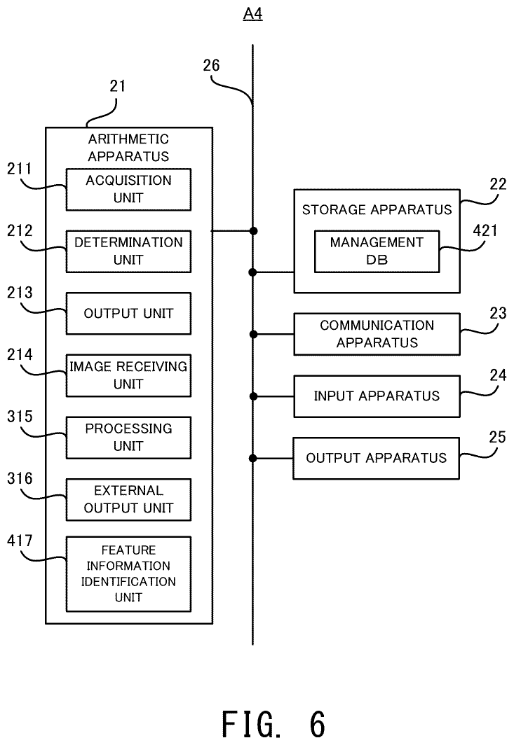

As illustrated in FIG. 6, the information processing apparatus A4 in the fourth example embodiment includes the arithmetic apparatus 21 and the storage apparatus 22, as in the information processing apparatus A2 in the second example embodiment and the information processing apparatus A3 in the third example embodiment. Furthermore, the information processing apparatus A4 in the fourth example embodiment may include the communication apparatus 23, the input apparatus 24, and the output apparatus 25, as in the information processing apparatus A2 in the second example embodiment and the information processing apparatus A3 in the third example embodiment. The information processing apparatus A4, however, may not include at least one of the communication apparatus 23, the input apparatus 24, and the output apparatus 25. The information processing apparatus A4 in the fourth example embodiment differs from the information processing apparatus A2 in the second example embodiment and the information processing apparatus A3 in the third example embodiment, in that the arithmetic apparatus 21 further includes a feature information identification unit 417. Other features of the information processing apparatus A4 may be the same as those of the information processing apparatus A2 in the second example embodiment or those of the information processing apparatus A3 in the third example embodiment. For this reason, a part differing from each of the example embodiments described above will be described in detail below, and a description of the other overlapping parts will be omitted as appropriate.

In the fourth example embodiment, the biometric information includes information indicating the iris. In the fourth example embodiment, the feature information and the registration feature information may include information indicating the features of the iris of the target person. In a management database 421 in the fourth example embodiment, the registration feature information is registered in association with the target person. In the management database 421, as illustrated in Table 1 below, the registration feature information may be registered in association with face information indicating a face of the target person, serving as identification information capable of identifying the target person.

TABLE 1
Management Database 421

| Identification | Face | Registration feature |
|---|---|---|
| information | information | information |
| AA | AAA | aaa |
| BB | BBB | bbb |
| CC | CCC | ccc |

The above Table 1 shows that registration feature information “aaa”, which indicates the features of the iris of a target person identifiable by identification information “AA”, is registered in association with face information “AAA”, which indicates the face of the target person. It also shows that registration feature information “bbb”, which indicates the features of the iris of a target person identifiable by identification information “BB”, is registered in association with face information “BBB”, which indicates the face of the target person. It also shows that registration feature information “ccc”, which indicates the features of the iris of a target person identifiable by identification information “CC”, is registered in association with face information “CCC”, which indicates the face of the target person.

### [4-2: Information Processing Operation Performed by Information Processing Apparatus A4]

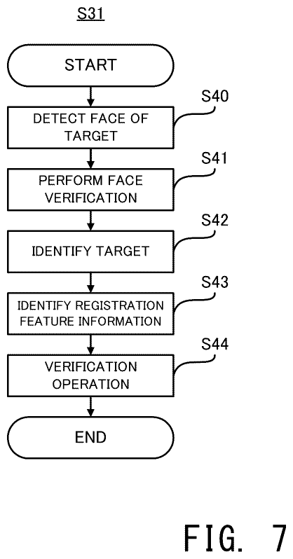

With reference to FIG. 7, an information processing operation performed by the information processing apparatus A4 in the fourth example embodiment will be described. FIG. 7 is a flowchart illustrating a flow of the information processing operation performed by the information processing apparatus A4 in the fourth example embodiment. FIG. 7 illustrates a specific flow of the information processing operation performed in the step S31 illustrated in FIG. 5.

As illustrated in FIG. 7, the feature information identification unit 417 detects a face area of the target person in the image (step S40). The feature information identification unit 417 matches the face area with the face information indicating the face registered in the management database 421, and performs face matching (step S41). The feature information identification unit 417 identifies who the target person is, by the face matching (step S42). The feature information identification unit 417 identifies the registration feature information that is registered in association with the target person (step S43). For example, in the case of the example illustrated in Table 1 above, when the information indicating the face area detected in the step S40 is “AAA”, the feature information identification unit 417 identifies the registration feature information on the target person to be “aaa”. The determination unit 212 matches the feature information acquired by the acquisition unit 211 with the identified registration feature information (step S44). The determination unit 212 determines whether or not unauthorized use of the information indicating the iris included in the image is possible, based on the matching result.

### [4-3: Technical Effect of Information Processing Apparatus A4]

The information processing apparatus A4 in the fourth example embodiment identifies the target person by the face matching, and determines whether or not the unauthorized use is possible, based on the result of matching with the registration feature information registered in advance. It is therefore possible to accurately determine whether or not the image of the iris is usable to identify the person to be authorized.

### 5: Fifth Example Embodiment

Next, an information processing apparatus, an information processing method, and a recording medium according to a fifth example embodiment will be described. The following describes the information processing apparatus, the information processing method, and the recording medium according to the fifth example embodiment, by using an information processing apparatus A5 to which the information processing apparatus, the information processing method, and the recording medium according to the fifth example embodiment are applied.

### [5-1: Configuration of Information Processing Apparatus A5]

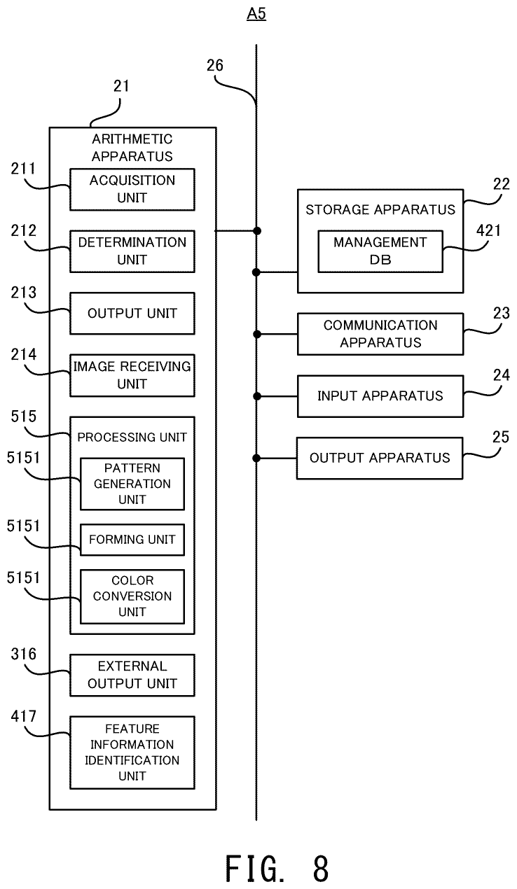

As illustrated in FIG. 8, the information processing apparatus A5 in the fifth example embodiment includes the arithmetic apparatus 21 and the storage apparatus 22, as in the information processing apparatus A2 in the second example embodiment to the information processing apparatus A4 in the fourth example embodiment. Furthermore, the information processing apparatus A5 in the fifth example embodiment may include the communication apparatus 23, the input apparatus 24, and the output apparatus 25, as in the information processing apparatus A2 in the second example embodiment to the information processing apparatus A4 in the fourth example embodiment. The information processing apparatus A5, however, may not include at least one of the communication apparatus 23, the input apparatus 24, and the output apparatus 25. The information processing apparatus A5 in the fifth example embodiment differs from the information processing apparatus A2 in the second example embodiment to the information processing apparatus A4 in the fourth example embodiment, in that the processing unit 515 includes a pattern generation unit 5151, a forming unit 5152, and a color conversion unit 5153. Other features of the information processing apparatus A5 may be the same as those of at least one of the information processing apparatus A2 in the second example embodiment to the information processing apparatus A4 in the fourth example embodiment. For this reason, a part differing from each of the example embodiments described above will be described in detail below, and a description of the other overlapping parts will be omitted as appropriate.

In the fifth example embodiment, the biometric information includes the information indicating the iris. In the fifth example embodiment, the feature information may include the information indicating the features of the iris of the target person.

### [5-2: Information Processing Operation Performed by Information Processing Apparatus A5]

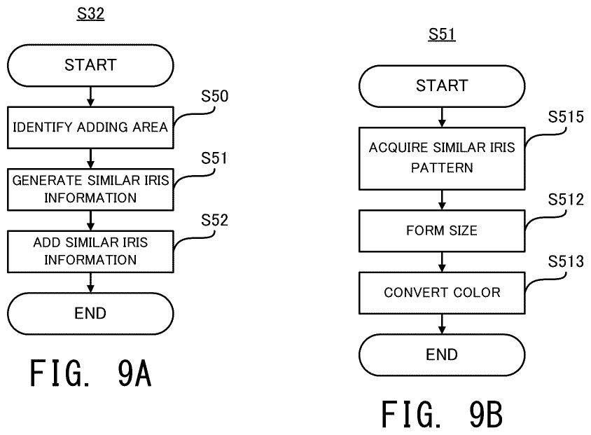

With reference to FIG. 9, an information processing operation performed by the information processing apparatus A5 in the fifth example embodiment will be described. FIG. 9 is a flowchart illustrating a flow of the information processing operation performed by the information processing apparatus A5 in the fifth example embodiment. FIG. 9 illustrates a specific flow of the information processing operation performed in the step S32 illustrated in FIG. 5.

As illustrated in FIG. 9(a), the processing unit 515 identifies, from the image, an area (hereinafter referred to as an “adding area”) corresponding to the iris area including the iris of the target person, serving as the feature area (step S50). The processing unit 515 generates similar iris information similarity to the iris area of the target person, serving as the processing information (step S51).

### [Step S51: Generation of Similar Iris Information]

As illustrated in FIG. 9(b), the pattern generation unit 5151 acquires a similar iris pattern (step S511). The similar iris pattern may be a pattern that does not impair the appearance of the iris area after processing, when it is used for processing. A case of not impairing the appearance, may be a case where the processing of the iris is hardly recognized when it is seen by a human being. The similar iris pattern may be a pattern that causes the iris area to lose its individuality after processing, when it is used for processing. A case of losing its individuality, may be a case where individuals cannot be identified. The pattern generation unit 5151 may select the similar iris pattern corresponding to the adding area, from among a plurality of candidate patterns. A single similar iris pattern may be prepared, and the pattern generation unit 5151 may acquire the prepared similar iris pattern. The pattern generation unit 5151 may generate the similar iris pattern, based on the corresponding adding area.

The forming unit 5152 generates a formed iris pattern in which a size of the similar iris pattern is formed to a size of the iris area of the target person (step S512). The color conversion unit 5153 converts a color of the formed iris pattern to a color similar to a color of the iris area of the target person, and generates the similar iris information (step S513).

The processing unit 515 adds the similar iris information to the adding area, and processes the image (step S52).

### [5-3: Technical Effect of Information Processing Apparatus A5]

The information processing apparatus A5 in the fifth example embodiment may prevent the unauthorized use of the image of the iris without impairing its appearance. The information processing apparatus A5 may prevent the unauthorized use of the image of the iris, by natural processing that is hardly recognized.

### 6: Sixth Example Embodiment

Next, an information processing apparatus, an information processing method, and a recording medium according to a sixth example embodiment will be described. The following describes the information processing apparatus, the information processing method, and the recording medium according to the sixth example embodiment, by using an information processing apparatus A6 to which the information processing apparatus, the information processing method, and the recording medium according to the sixth example embodiment are applied.

### [6-1: Configuration of Information Processing Apparatus A6]

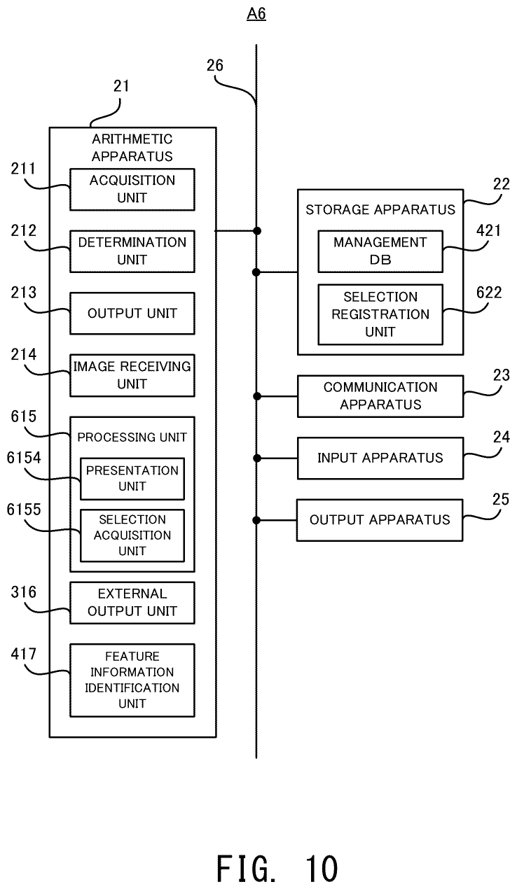

As illustrated in FIG. 10, the information processing apparatus A6 in the sixth example embodiment includes the arithmetic apparatus 21 and the storage apparatus 22, as in the information processing apparatus A2 in the second example embodiment to the information processing apparatus A5 in the fifth example embodiment. Furthermore, the information processing apparatus A6 in the sixth example embodiment may include the communication apparatus 23, the input apparatus 24, and the output apparatus 25, as in the information processing apparatus A2 in the second example embodiment to the information processing apparatus A5 in the fifth example embodiment. The information processing apparatus A6, however, may not include at least one of the communication apparatus 23, the input apparatus 24, and the output apparatus 25. The information processing apparatus A6 in the sixth example embodiment differs from the information processing apparatus A2 in the second example embodiment to the information processing apparatus A5 in the fifth example embodiment, in that the processing unit 615 further includes a presentation unit 6154 and a selection acquisition unit 6155, and in that the storage apparatus 22 further includes a selection registration unit 622. Other features of the information processing apparatus A6 may be the same as those of at least one of the information processing apparatus A2 in the second example embodiment to the information processing apparatus A5 in the fifth example embodiment. For this reason, a part differing from each of the example embodiments described above will be described in detail below, and a description of the other overlapping parts will be omitted as appropriate.

### [6-2: Information Processing Operation Performed by Information Processing Apparatus A6]

The processing unit 615 in the sixth example embodiment is configured to perform the processing by using a plurality of processing methods. The processing methods that are practicable, may include, for example, a processing method for increasing an outer diameter of the iris area. The processing methods that are practicable, may also include a processing method for superimposing a specific pattern on the iris area. The processing methods that are practicable, may also include a processing method for discoloring the iris area to a specific color.

The presentation unit 6154 presents the target person with the plurality of processing methods that are practicable by the processing unit 615. The presentation unit 6154 may control the communication apparatus 23 or the output apparatus 25 to present the target person with the plurality of processing methods that are practicable by the processing unit 615. For example, the presentation unit 6154 may present the target person with the plurality of processing methods that are practicable by the processing unit 615 such that the target person is able to select a processing method the target person wishes to use, so as to select a pattern contact lens. The target person may select the processing method the target person wishes to use, from the plurality of processing methods presented.

The selection acquisition unit 6155 acquires information indicating the processing method selected by the target person. The selection acquisition unit 6155 may acquire the processing method selected by the target person, via the communication apparatus 23 or the input apparatus 24. The acquired processing method may be registered in the selection registration unit 622, which is realized in the storage apparatus 22, for example. An operation of presenting the processing methods by the presentation unit 6154 and an operation of acquiring a selection result by the selection acquisition unit 6155 may be performed in timing when the target person becomes the user, in timing when the output unit 213 outputs an alert, or in similar timing.

The processing unit 615 performs the processing, by using the processing method selected by the target person from among the plurality of processing methods during a predetermined period. The predetermined period may be a period set in advance. The predetermined period may be a period designated by the target person. The predetermined period may be, for example, one month. The target person may be able to change the selection of the processing method in any timing.

### [6-3: Technical Effect of Information Processing Apparatus A6]

The information processing apparatus A6 in the sixth example embodiment may prevent the unauthorized use of the image, while processing the image by using the processing method desired by the target person. In addition, the processing unit 615 performs the processing by using the processing method selected by the target person from among the plurality of processing methods during the predetermined period, and therefore, the target person may not select the processing method at each time of processing.

### 7: Seventh Example Embodiment

Next, an information processing apparatus, an information processing method, and a recording medium according to a seventh example embodiment will be described. The following describes the information processing apparatus, the information processing method, and the recording medium according to the seventh example embodiment, by using an information processing apparatus A7 to which the information processing apparatus, the information processing method, and the recording medium according to the seventh example embodiment are applied.

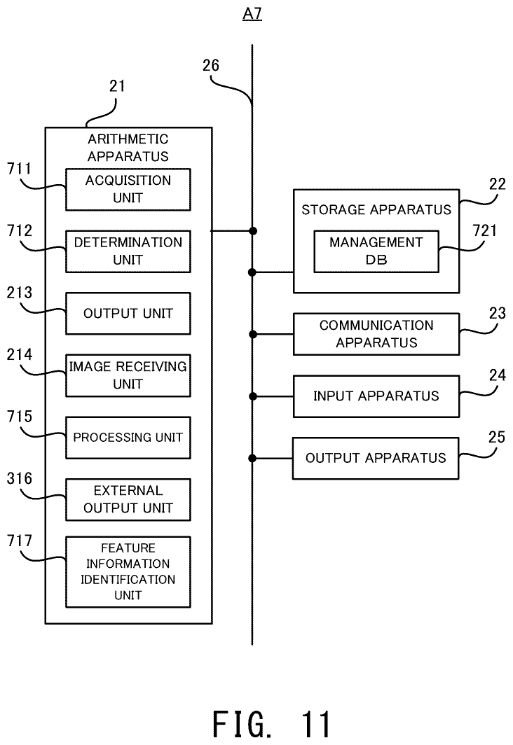

FIG. 11 illustrates a configuration of the information processing apparatus A7 in the seventh example embodiment. In the seventh example embodiment, the operation of an acquisition unit 711, a determination unit 712, and a feature information identification unit 717 differs from those in the second to sixth example embodiments. In addition, the information registered in a management database 721 is different in the seventh example embodiment. Other features of the information processing apparatus A7 may be the same as those of at least of the information processing apparatus A2 in the second example embodiment to the information processing apparatus A6 in the sixth example embodiment. For this reason, apart differing from each of the example embodiments described above will be described in detail below, and a description of the other overlapping parts will be omitted as appropriate.

### [7-1: Information Processing Operation Performed by Information Processing Apparatus A7]

In the second to sixth example embodiments, the acquisition unit 211 may acquire the feature information by using a first extraction engine E1 that extracts the feature vector by using a first extraction method. In addition, the feature vector extracted by the first extraction engine E1 may be registered in the management database 221.

In contrast, in the seventh example embodiment, the acquisition unit 711 may use the first extraction engine E1 that extracts the feature vector serving as the feature information by using the first extraction method, and one or more second extraction engines E2, each of which extracts the feature vector by using a different extraction method from the first extraction method. That is, in the seventh example embodiment, the acquisition unit 711 may extract a plurality of feature vectors respectively indicating different features, by using a plurality of extraction methods.

For example, even if the feature vector is extracted from an image with low brightness by using any of the extraction methods, the matching using the feature vector may have a high success rate. Furthermore, even if the feature vector is extracted from an image with low resolution by using any of the extraction methods, the matching using the feature vector may have a high success rate. In this way, each extraction method may have different features. It may be said that each extraction method has different strength.

In the seventh example embodiment, not only a first feature vector extracted by the first extraction engine E1, but also a second feature vector extracted by the one or more second extraction engines E2, each of which extracts the feature vector by using a different extraction method from the first extraction method, is registered in the management database 721. That is, in the seventh example embodiment, the feature vectors registered in the management database 721 include the second feature vector, in addition to the first feature vector. For example, as illustrated in Table 2 below, “aaa1” serving as the first feature vector extracted by the first extraction engine E1 and “aaa2” serving as the second feature vector extracted by the second extraction engine E2, may be registered in the management database 721, for the target person identifiable by the identification information “AA”. In addition, “bbb1” serving as the first feature vector extracted by the first extraction engine E1 and “bbb21” and “bbb22” serving as the second feature vectors extracted by the second extraction engine E2, may be registered in the management database 721, for the target person identifiable by the identification information “BB”. Since the second extraction engine E2 includes one or more extraction engines E, each of which extracts the feature vector by using a different extraction method from the first extraction method, “bbb21” and “bbb22” may be the feature vectors extracted by using different extraction methods. The second feature vector “bbb21” may be a feature vector extracted by an extraction engine E21, and the second feature vector ‘bbb22’ may be a feature vector extracted by an extraction engine E22. In addition, “ccc1” serving as the first feature vector extracted by the first extraction engine E1 and “ccc2” serving as the second feature vector extracted by the second extraction engine E2, may be registered in the management database 721, for the target person identifiable by the identification information “CC”.

TABLE 2
Management database 721

| | | | Registration |
|---|---|---|---|
| Identification | Face | Extraction | feature |
| information | information | engine | information |
| AA | AAA | 1 | aaa1 |
| AA | AAA | 2 | aaa2 |
| BB | BBB | 1 | bbb1 |
| BB | BBB | 21 | bbb21 |
| BB | BBB | 22 | bbb22 |
| CC | CCC | 1 | ccc1 |
| CC | CCC | 2 | ccc2 |

In the seventh example embodiment, so as to deal with various possible cases, it is possible to use the second extraction engine E2 other than the first extraction engine E1 used in the second to sixth example embodiments. This makes it possible to prevent the unauthorized use of the biometric information, in an environment outside the control of the information processing apparatus A7, for example.

In the seventh example embodiment, the feature information identification unit 717 identifies one or more registration feature vectors that are registered in association with the target person included in the image, from the feature vectors registered in the management database 721. That is, in the seventh example embodiment, the feature information identification unit 717 may identify the second feature vector acquired by the second extraction engine E2, in addition to the first feature vector acquired by the first extraction engine E1.

The feature vector acquired by the acquisition unit 711 from the image processed by the processing unit 715 is referred to as a processed feature vector. In the seventh example embodiment, the determination unit 712 matches the processed feature vector acquired by the acquisition unit 711 with one or more registration feature vectors identified by the feature information identification unit 717. The determination unit 712 may match the processed feature vector extracted by the first extraction engine E1 with the registration feature vector extracted by the first extraction engine E1. The determination unit 712 may also match the processed feature vector extracted by the second extraction engine E2 with the registration feature vector extracted by the second extraction engine E2. In addition to the matching between the feature vectors extracted by the same extraction engine E, the determination unit 712 may also match the feature vectors extracted by different extraction engines E.

The determination unit 712 determines whether or not the matching is successful. When the matching is successful, the processing unit 715 changes the processing method and performs the processing. When at least one matching is successful, the processing unit 715 may change the processing method and perform the processing.

### [Processing Operations in Seventh Example Embodiment]

The processing unit 715 performs the processing such that the determination unit 712 does not determine that the matching is successful between the processed feature vector acquired by the acquisition unit 711 and one or more registration feature vectors identified by the feature information specification unit 717. That is, the processing unit 715 performs the processing such that the determination unit 712 does not determine that the unauthorized use is possible.

In the seventh example embodiment, the determination unit 712 may be allowed to use a plurality of matching engines, each of which has different features. Each matching engine may correspond to respective one of the extraction engines E. The processing unit 715 may perform the processing such that the matching is not successful even when the determination unit 712 uses the matching engine with the highest processing capacity that is usable by the determination unit 712. The matching engine with a high processing capacity may be, for example, an engine that allows a success in the matching, even when noise is superimposed on the image. In addition, the processing unit 715 may perform the processing such that there is no success in the matching using all the matching engines that are usable by the determination unit 712. The processing unit 715 performs the processing by using a processing method that satisfies at least one of: a processing method that does not allow a success in the matching using the matching engine with the highest processing capacity that is usable by the determination unit 712; and a processing method that does not allow a success in the matching using all the matching engines that are usable by the determination unit 712.

The features of the matching engine may be such features that even the feature vector extracted from the image with low brightness is usable for the matching with a high success rate. The features of the matching engine may also be such features that even the feature vector extracted from the image with low resolution is usable for the matching with a high success rate. Furthermore, the determination unit 712 may determine the possibility of the unauthorized use by changing a threshold of the matching.

### [7-2: Technical Effect of Information Processing Apparatus A7]

The information processing apparatus A7 in the seventh example embodiment may prevent the unauthorized use of the image, even in the environment outside the control of the information processing apparatus A7. For example, in a case where the engine in the environment outside the control of the information processing apparatus A7 has a higher processing capacity than that of the engine that is usable in the information processing apparatus A7, changing the processing method makes it possible to prevent the unauthorized use. By performing the processing using various conceivable processing methods, the information processing apparatus A7 may properly process the image such that the matching of the processed feature vector is not successful, regardless of which matching engine is used.

### 8: Eighth Example Embodiment

Next, an information processing apparatus, an information processing method, and a recording medium according to an eighth example embodiment will be described. The following describes the information processing apparatus, the information processing method, and the recording medium according to the eighth example embodiment, by using an information processing apparatus A8 to which the information processing apparatus, the information processing method, and the recording medium according to the eighth example embodiment are applied.

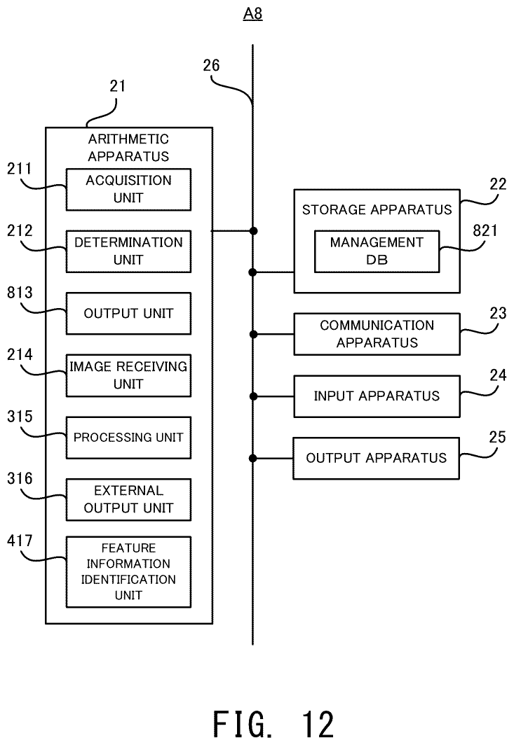

FIG. 12 illustrates a configuration of the information processing apparatus A8 in the eighth example embodiment. In the eighth example embodiment, the operation of an output unit 813 differs from those in the second to seventh example embodiments. In addition, the information registered in a management database 821 is different in the eighth example embodiment. Other features of the information processing apparatus A7 may be the same as those of at least one of the information processing apparatus A2 in the second example embodiment to the information processing apparatus A7 in the seventh example embodiment. For this reason, a part differing from each of the example embodiments described above will be described in detail below, and a description of the other overlapping parts will be omitted as appropriate.

### [8-1: Information Processing Operation Performed by Information Processing Apparatus A8]

### [Execution Timing]

The information processing apparatus A8 may perform the information processing operation in at least one of: a case where the image becomes processable by the information processing apparatus A8; and a case where the image is outputted to an outside of the information processing apparatus A8. The case where the image becomes processable by the information processing apparatus A8 may include a case where the image is uploaded to the information processing apparatus A8.

In the management database 821 in the eighth example embodiment, as illustrated in Table 3 below, information indicating whether or not the processing is necessary for each type of biometric information, may be registered for each user who uses a service provided by the information processing apparatus A8.

TABLE 3
Management Database 821

| Identification | | Necessity of |
|---|---|---|
| information | Type | processing |
| AA | Iris | Necessary |
| AA | Face | Unnecessary |
| BB | Iris | Necessary |
| BB | Face | Necessary |
| CC | Iris | Unnecessary |
| CC | Face | Unnecessary |

The above Table 3 shows that for the user identifiable by the identification information “AA”, the processing is necessary for the “iris”, but the processing is unnecessary for the “face”. It also shows that for user identifiable by the identification information “BB”, the processing is necessary for both the “iris” and the “face”. It also shows that for the user identifiable by the identification information “CC”, the processing is unnecessary for both the “iris” and the “face”.

For example, in the above Table 3, it may be understood that the user identifiable by the identification information “AA” considers that there is a problem if leakage occurs for the “iris”. On the other hand, it may be understood that the user identifiable by the identification information “AA” considers that there is no problem even if leakage occurs for the “face”. In addition, it may be understood that the user identifiable by the identification information “BB” considers that there is a problem if leakage occurs for the “iris” and the “face”. In addition, it may be understood that the use identifiable by the identification information “CC” considers that there is no problem even if leakage occurs for the “iris” and the “face”. In this way, which type of biometric information leakage is a problem, varies depending on the user.

The output unit 813 does not output an alert, when the determination unit 212 determines that the unauthorized use of the biometric information is possible, by using the feature information acquired from the type of biometric information that does not require the processing.

In the management database 821 in the eighth example embodiment, the information indicating whether or not the processing is necessary for each type of biometric information, may be registered. Therefore, the output unit 813 is allowed to output an alert accordingly. Even when information indicating that the processing is unnecessary, is registered in the management database 821, the determination unit 212 may still perform the determination operation. In this case, for example, a service for providing the user with information indicating how much information, which is usable for unauthorized purposes, is outputted to an outside of the information processing apparatus A7.

### [8-2: Technical Effect of Information Processing Apparatus A8]

The information processing apparatus A8 in the eighth example embodiment may control whether or not to output an alert, depending on the user and the type of the biometric information.

### 9: Ninth Example Embodiment

Next, an information processing apparatus, an information processing method, and a recording medium according to a ninth example embodiment will be described. The following describes the information processing apparatus, the information processing method, and the recording medium according to the ninth example embodiment, by using an information processing apparatus A9 to which the information processing apparatus, the information processing method, and the recording medium according to the ninth example embodiment are applied.

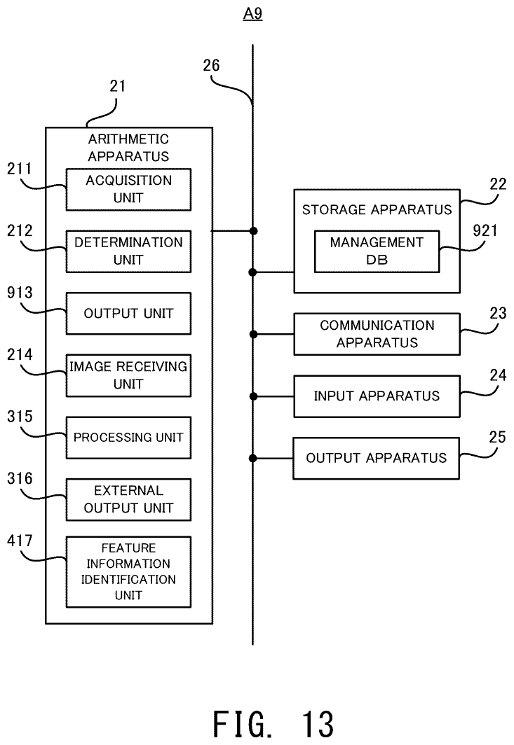

FIG. 13 illustrates a configuration of the information processing apparatus A9 in the ninth example embodiment. In the ninth example embodiment, the operation of an output unit 913 differs from that in the second to eighth example embodiments. In addition, the information registered in a management database 921 is different in the ninth example embodiment. Other features of the information processing apparatus A9 may be the same as those of at least one of the information processing apparatus A2 in the second example embodiment to the information processing apparatus A8 in the eighth example embodiment. For this reason, a part differing from each of the example embodiments described above will be described in detail below, and a description of the other overlapping parts will be omitted as appropriate.

### [9-1: Information Processing Operation Performed by Information Processing Apparatus A9]

### [Execution Timing]

The information processing apparatus A9 may perform the information processing operation in at least one of: a case where the image becomes processable by the information processing apparatus A9; and a case where the image is outputted to an outside of the information processing apparatus A9. The case where the image becomes processable by the information processing apparatus A9 may include a case where the image is uploaded to the information processing apparatus A9.

In the management database 921 in the ninth example embodiment, as illustrated in Table 4 below, information indicating whether or not the output of an alert is necessary, may be registered for each user who uses a service provided by the information processing apparatus A9.

TABLE 4
Management database 921

| Identification | |
|---|---|
| information | Necessity of alert |
| AA | Unnecessary |
| BB | Unnecessary |
| CC | Necessary |

The above Table 4 shows that the output of an alert is unnecessary for the user identifiable by the identification information “AA”, that the output of an alert is unnecessary for the user identifiable by the identification information “BB”, and that the output of an alert is necessary for he users identifiable by the identification information “CC”.

The output unit 913 does not output an alert to the user for whom the output of an alert is unnecessary, even when the determination unit 212 determines that the biometric information on the user in question is usable for unauthorized purposes. For example, in the case of an image only including the user, such as a selfie, it is unnecessary to output an alert.

The acquisition unit 211 may detect whether the image includes a target person other than the user. The determination unit 212 may perform a determination operation of determining whether or not the biometric information on the target person other than the user is usable for unauthorized purposes. In this case, when the determination unit 212 determines that the biometric information on the target person included in the image other than the user is usable for unauthorized purposes, at least one of the output of an alert by the output unit 913 and the processing of the biometric information on the target person by the processing unit 315, may be performed.

Alternatively, when the determination unit 212 determines that the biometric information on the target person included in the image other than the user for whom the output of an alert is unnecessary, is usable for unauthorized purposes, the output of an alert by the output unit 913 may not be performed, but the processing of the biometric information on the target person by the processing unit 315 may be performed. Since the user considers that the output of an alert is unnecessary, the output unit 913 may not output an alert even for the target person included in the image other than the user. Even when the user considers that the output of an alert is unnecessary, the processing of the biometric information, or the like, may be carried out so as to prevent/control the unauthorized use, for another person who does not consider being disclosed to a large number of unspecified people.

### [9-2: Technical Effect of Information Processing Apparatus A9]

The information processing apparatus A9 in the ninth example embodiment is configured to control whether or not to output an alert depending on the user, thereby to output an appropriate alert. In addition, even when the user does not require an alert, in a case where the biometric information on the target person included in the image other than the user is usable for unauthorized purposes, the information processing apparatus A9 performs at least one of the output of an alert and the processing of the biometric information that is usable for unauthorized purposes, and it may therefore prevent the unauthorized use of the biometric information on the target person included in the image other than the user.

### 10: Tenth Example Embodiment

Next, an information processing apparatus, an information processing method, and a recording medium according to a tenth example embodiment will be described. The following describes the information processing apparatus, the information processing method, and the recording medium according to the tenth example embodiment, by using an information processing apparatus A10 to which the information processing apparatus, the information processing method, and the recording medium according to the tenth example embodiment are applied.

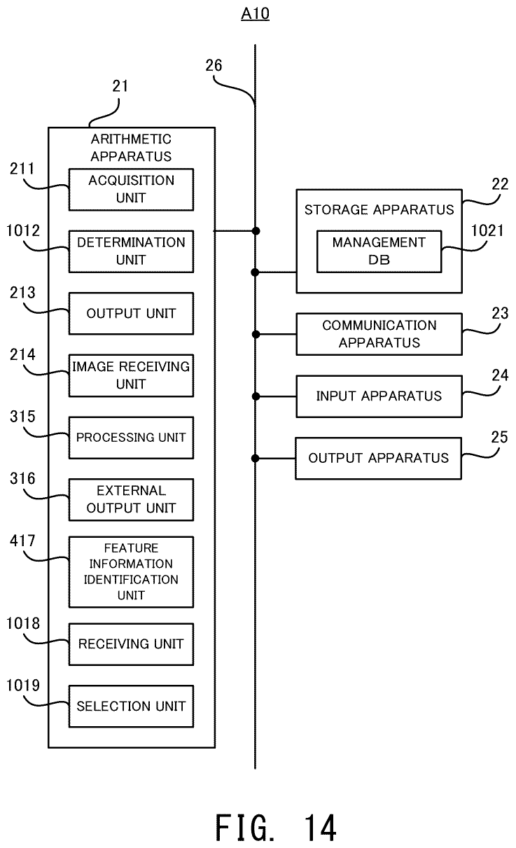

As illustrated in FIG. 14, the information processing apparatus A10 in the tenth example embodiment includes the arithmetic apparatus 21 and the storage apparatus 22, as in the information processing apparatus A2 in the second example embodiment to the information processing apparatus A9 in the ninth example embodiment. Furthermore, the information processing apparatus A10 in the tenth example embodiment may include the communication apparatus 23, the input apparatus 24, and the output apparatus 25, as in the information processing apparatus A2 in the second example embodiment to the information processing apparatus A9 in the ninth example embodiment. The information processing apparatus A10, however, may not include at least one of the communication apparatus 23, the input apparatus 24, and the output apparatus 25. The information processing apparatus A10 in the tenth example embodiment differs from the information processing apparatus A2 in the second example embodiment to the information processing apparatus A9 in the ninth example embodiment, in that the arithmetic apparatus 21 further includes a receiving unit 1018 and a selection unit 1019, in the operation of a determination unit 1012, and in the information registered in a management database 1021. Other features of the information processing apparatus A10 may be the same as those of at least one of the information processing apparatus A2 in the second example embodiment to the information processing apparatus A9 in the ninth example embodiment. For this reason, a part differing from each of the example embodiments described above will be described in detail below, and a description of the other overlapping parts will be omitted as appropriate.

### [10-1: Information Processing Operation Performed by Information Processing Apparatus A10]

The management database 1021 in the tenth example embodiment includes a plurality of images including the user. In the management database 1021, the images acquired by the image receiving unit 214 may be stored without being deleted.

The receiving unit 1018 receives/accepts a request from the user to make all the images held by the information processing apparatus A10 unusable for unauthorized purposes. The selection unit 1019 selects all images including the user from among the images stored in the management database 1021.

The selection unit 1019 may detect faces in the images and may select an image(s) including the user by the face matching. The selection unit 1019 may detect irises in the images and may select an image(s) including the user by iris matching. Furthermore, the selection unit 1019 may not select an image(s) including the biometric information that is already processed. Since the purpose of the selection is to perform the processing such that the matching by the determination unit 1012 is not successful, the biometric information for which the matching by the determination unit 1012 is not successful does not need to be processed. Therefore, the selection unit 1019 may not select an image(s) including the biometric information that is already processed.

The determination unit 1012 performs a determination operation on all the selected images. The processing unit 315 processes the image including the biometric information that is determined by the determination unit 1012 to be unusable for unauthorized purposes.

The selection unit 1019 may search for an image(s) including the target person such as, for example, images used in social networking services in the past. The determination unit 1012 may determine whether or not the unauthorized use is possible for all the images searched for. The management database 1021 may replace the stored images that are unusable for unauthorized purposes with the processed images.

### [10-2: Technical Effect of Information Processing Apparatus A10]

The information processing apparatus A10 in the tenth example embodiment may prevent the unauthorized use of at least the images managed by the information processing apparatus A10 if the user so wishes. The information processing apparatus A10 may also prevent the unauthorized use of the past images.

### 11: Eleventh Example Embodiment

Next, an information processing apparatus, an information processing method, and a recording medium according to an eleventh example embodiment will be described. The following describes the information processing apparatus, the information processing method, and the recording medium according to the eleventh example embodiment, by using an information processing apparatus A11 to which the information processing apparatus, the information processing method, and the recording medium according to the eleventh example embodiment are applied.

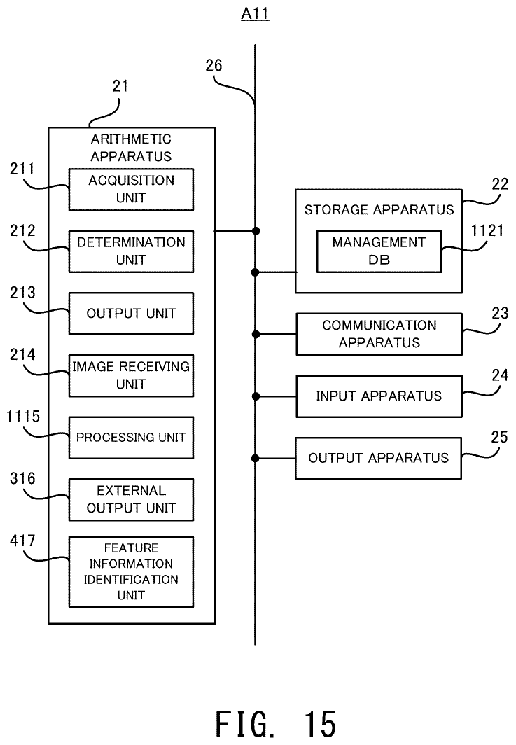

FIG. 15 illustrates a configuration of the information processing apparatus A11 in the eleventh example embodiment. In the eleventh example embodiment, the operation of a processing unit 1115 differs from those in the second to tenth example embodiments. In addition, the information registered in a management database 1121 is different in the eleventh example embodiment. Other features of the information processing apparatus A11 may be the same as those of at least one of the information processing apparatus A2 in the second example embodiment to the information processing apparatus A10 in the tenth example embodiment. For this reason, a part differing from each of the example embodiments described above will be described in detail below, and a description of the other overlapping parts will be omitted as appropriate.

### [11-1: Information Processing Operation Performed by Information Processing Apparatus A11]

In the management database 1121 in the eleventh example embodiment, a target who is other than, but related to the user, is registered in association with the user who uses a service provided by the information processing apparatus A11.

That is, even for a target person who is not the user of the service provided by the information processing apparatus A11, the information processing apparatus A11 may prevent the unauthorized use of the biometric information on the target person captured in the image together with the user. For example, at the start of use of the service provided by the information processing apparatus A11, the target person other than the user may also be registered in the management database 1121, as a person to be processed.

In the management database 1121 in the eleventh example embodiment, a degree of processing by the processing unit 1115 is set for each user who uses the service provided by the information processing apparatus A11. The degree of processing may be intensity of processing. The degree of processing may be correlated with the success rate of the matching. For example, as the degree of processing increases, the matching may be less likely successful. In addition, as the degree of processing increases, it may be harder to perform the unauthorized use. In addition, as the degree of processing decreases, the matching may be more likely successful.

In the management database 1121, the degree of processing by the processing unit 1115 may be set for each registered target person, including the user and the target who is other than, but related to the user.

In the management database 1121, as illustrated in Table 5 below, the intensity of processing by the processing unit 1115 may be set for each registered target person. The Table 5 below shows that information on the user identifiable by the identification information “AA” and information on a target person identifiable by identification information “XX” are registered. It also shows that information on the user identifiable by the identification information “BB” and information on a target person identifiable by identification information “YY” are registered. It also shows that information on the user identifiable by the identification information “CC” and information of a target person identifiable by identification information “ZZ” are registered.

TABLE 5
Management Database 1121

| Target person | User | |
|---|---|---|
| identification | identification | |
| information | information | Intensity |
| AA | AA | Intermediate |
| XX | AA | High |
| BB | BB | Low |
| YY | BB | Low |
| CC | CC | High |
| ZZ | CC | High |

The above Table 5 shows that the processing with “Intermediate” intensity that is neither intense nor mild, is set for the target person identifiable by the identification information “AA”. It also shows that the processing with “high” intensity is set for the target person identifiable by the identification information “XX”. It also shows that the processing with “low” intensity is set for the target person identifiable by the identification information “BB”. It also shows that the processing with “low” intensity is set for the target person identifiable by the identification information “YY”. It also shows that the processing with “high” intensity is set for the target person identifiable by the identification information “CC”. It also shows that the processing with “high” intensity is set for the target person identifiable by the identification information “ZZ”.

The processing unit 1115 may add the processing information corresponding to the set intensity, to an area corresponding to the feature information in the image. In a case where the target person in the image is the user identifiable by the identification information “AA”, the processing unit 1115 may add the processing information corresponding to the intermediate intensity, to the area corresponding to the feature information. In a case where the target person in the image is the user identifiable by the identification information “BB”, the processing unit 1115 may add the processing information corresponding to the low intensity, to the area corresponding to the feature information. In a case where the target person in the image is the user identifiable by the identification information “CC”, the processing unit 1115 may add the processing information corresponding to the high intensity, to the area corresponding to the feature information.

In addition, the processing unit 1115 may change the degree of processing depending on magnitude/size of the feature information in the image. For example, even when the target person included in the image is the user identifiable by the identification information “AA”, in a case where the magnitude/size of the feature information included in the image is greater than a first predetermined size, the processing unit 1115 may add the processing information corresponding to the high intensity, to the area corresponding to the feature information. Alternatively, even when the target person included in the image is the user identifiable by the identification information “AA”, in a case where the magnitude/size of the feature information included in the image is less than a second predetermined size that is smaller than the first predetermined size, the processing unit 1115 may add the processing information corresponding to the low intensity, to the area corresponding to the feature information.

The processing unit 1115 may perform the processing on the biometric information on the user and the biometric information on another person captured in the image together with the user. For example, in the determination of the magnitude/size of the biometric information in the image, in a case where the size of the biometric information on the other person is greater than that of the biometric information on the user in the same image, the processing unit 1115 may set the intensity of processing for the other person to be higher than the intensity of processing set by the user, and may then perform the processing. In addition, in a case where the processing unit 1115 determines that the other person is captured in the image larger than the predetermined size, it may determine that predetermined intensity of processing is insufficient for the processing and may the processing with higher intensity.

In a case where the target person captured in the image is a target person of the service provided by information processing apparatus A11, it is possible to determine whether or not the unauthorized use is possible by the matching with the registration feature information registered in the management database 1121. On the other hand, in a case where the target person captured in the image is not the target person of the service provided by information processing apparatus A11, whether or not the unauthorized use is possible may be determined by the matching with the feature information extracted from an arbitrary image that is generally available. For example, it may be determined that the unauthorized use is not possible, in a case where it is hardly possible to obtain the image of a person who is deemed to be the same person by the matching with the feature information obtained from the image of a target person who is not the target person of the service provided by information processing apparatus A11.

### [11-2: Technical Effect of Information Processing Apparatus A11]

The information processing apparatus A11 in the eleventh example embodiment is configured to change the degree of processing depending on the user, thereby to perform appropriate processing. Since the information processing apparatus A11 is configured to change the degree of processing depending on a size of the feature area, it may perform the processing such that it is harder to perform the unauthorized use is performed when the captured feature area is large, for example. Furthermore, the information processing apparatus A11 is configured to change the degree of processing depending on the target person other than the user himself/herself.

### 12: Supplementary Notes

With respect to the example embodiments described above, the following Supplementary Notes are further disclosed.

### [Supplementary Note 1]

An information processing apparatus including:
an acquisition unit that acquires, from biometric information on a target included in an image, feature information indicating features of the biometric information;
a determination unit that performs a determination operation of determining whether or not unauthorized use of the biometric information is possible, by using the feature information; and
an output unit that outputs an alert in response to the determination by the determination unit that the unauthorized use is possible.

### [Supplementary Note 2]

The information processing apparatus according to Supplementary Note 1, wherein the determination unit matches the feature information acquired by the acquisition unit with registration feature information registered in advance, and makes the determination based on the matching result.

### [Supplementary Note 3]

The information processing apparatus according to Supplementary Note 1 or 2, wherein the output unit outputs the alert to at least one of the target and a person who a person who makes the image processable in the information processing apparatus.

### [Supplementary Note 4]

The information processing apparatus according to Supplementary Note 1 or 2, further including a processing unit that processes the image by adding processing information to an area corresponding to a feature area in the image in which the acquisition unit acquires the feature information.

### [Supplementary Note 5]

The information processing apparatus according to Supplementary Note 4, further including an external output unit that, in a case of outputting the image to an outside of the information processing apparatus, processes the image by using the processing unit in response to the determination by the determination unit in the determination operation that the unauthorized use is possible, and that outputs the processed image to the outside of the information processing apparatus.

### [Supplementary Note 6]

The information processing apparatus according to Supplementary Note 1 or 2, further including a feature information identification unit that performs face matching on the target included in the image, that identifies the target, and that identifies registration feature information registered in association with the target, wherein the determination unit matches the feature information acquired by the acquisition unit with the registration feature information, and makes the determination based on the matching result.

### [Supplementary Note 7]

The information processing apparatus according to Supplementary Note 5, wherein the processing unit
processes the image by adding,
to an area corresponding to an iris area including an iris of the target, serving as the feature area,
similar iris information similarity to the iris area, serving as the processing information.

### [Supplementary Note 8]

The information processing apparatus according to Supplementary Note 7, wherein the processing unit:
acquires a similar iris pattern;
generates a formed iris pattern in which a size of the similar iris pattern is formed to a size of the iris area;
converts a color of the formed iris pattern to a color similar to a color of the iris area;
generates the similar iris information; and
processes the image by adding the similar iris information to the area corresponding to the iris area.

### [Supplementary Note 9]

The information processing apparatus according to Supplementary Note 4, further including a presentation unit that presents the target with a plurality of processing methods that are practicable by the processing unit, wherein
the processing unit performs processing, by using a processing method selected by the target from among the plurality of processing methods during a predetermined period.

### [Supplementary Note 10]

The information processing apparatus according to Supplementary Note 5, further including:
a registration unit in which feature information is registered, the feature information including first feature information acquired by a first extraction engine that extracts feature information by using a first extraction method, and second feature information acquired by one or more second extraction engines, each of extracts feature information by using a different extraction method from the first extraction method; and
a feature information identification unit that identifies one or more pieces of registration feature information registered in association with the target included in the image, from the feature information registered in the registration unit, wherein
the acquisition unit is configured to use the first extraction engine and the one or more second extraction engines,
the determination unit matches processed feature information acquired by the acquisition unit from the image processed by the processing unit, with the one or more pieces of registration feature information, and
the processing unit changes a processing method, based on the matching result by the determination unit.

### [Supplementary Note 11]

The information processing apparatus according to Supplementary Note 10, wherein
the processing unit performs processing by using a processing method that satisfies at least one of
   a processing method that does not allow a success in matching using a matching engine with a highest processing capacity that is usable by the determination unit; and
   a processing method that does not allow a success in matching using all of matching engines that are usable by the determination unit,
such that the determination unit does not determine that the unauthorized use is possible, from a matching result between the processed feature information and the one or more pieces of registration feature information.

### [Supplementary Note 12]

The information processing apparatus according to Supplementary Note 1 or 2, wherein
information indicating whether or not processing is necessary for each type of biometric information, is registered for each user who uses a service provided by the information processing apparatus, and
the output unit does not output an alert, in response to the determination by the determination unit that the unauthorized use of the biometric information is possible, by using the feature information acquired from a type of biometric information that does not require processing.

### [Supplementary Note 13]

The information processing apparatus according to Supplementary Note 1 or 2, wherein
information indicating whether or not an output of an alert is necessary, is registered for each user who uses a service provided by the information processing apparatus, and
the output unit does not output an alert to the user for whom the output of an alert is unnecessary, even in a case of the determination by the determination unit that the biometric information on the target is usable for unauthorized purposes.

### [Supplementary Note 14]

The information processing apparatus according to Supplementary Note 5, wherein
information indicating whether or not an output of an alert is necessary, is registered for each user who uses a service provided by the information processing apparatus, and
in response to the determination by the determination unit that the biometric information on the target included in the image other than the user who does not require the output of an alert is usable for unauthorized purposes, at least one of the output of an alert by the output unit and processing of the biometric information on the target by the processing unit, is performed.

### [Supplementary Note 15]

The information processing apparatus according to Supplementary Note 5, wherein
the determination unit:
   selects all images including the target from among images stored in a database; and
   makes the determination for all the selected images, and
the processing unit processes the image including the biometric information that is determined by the determination unit to be unusable for unauthorized purposes.

### [Supplementary Note 16]

The information processing apparatus according to Supplementary Note 5, wherein
a degree of processing by the processing unit is set for each user who uses a service provided by the information processing apparatus, and
the processing unit adds processing information corresponding to the set degree, to the area corresponding to the feature area in the image.

### [Supplementary Note 17]

The information processing apparatus according to Supplementary Note 16, wherein the processing unit changes the degree of processing, depending on a size of the feature area in the image.

### [Supplementary Note 18]

The information processing apparatus according to Supplementary Note 16, wherein
a target who is other than, but related to the user, is registered in association with the user, and
the degree of processing by the processing unit is set for each registered target.

### [Supplementary Note 19]

An information processing method including:
acquiring, from biometric information on a target included in an image, feature information indicating features of the biometric information;
performing a determination operation of determining whether or not unauthorized use of the biometric information is possible, by using the feature information; and
outputting an alert in response to the determination that the unauthorized use is possible.

### [Supplementary Note 20]

A recording medium on which a computer program that allows a computer to execute an information processing method is recorded, the information processing method including:
acquiring, from biometric information on a target included in an image, feature information indicating features of the biometric information;
performing a determination operation of determining whether or not unauthorized use of the biometric information is possible, by using the feature information; and
outputting an alert in response to the determination that the unauthorized use is possible.

This disclosure is allowed to be changed, if desired, without departing from the essence or spirit of this disclosure which can be read from the claims and the entire identification. An information processing apparatus, an information processing method, and a recording medium with such changes are also intended to be within the technical scope of this disclosure.

### DESCRIPTION OF REFERENCE CODES

A1, A2, A3, A4, A5, A6, A7, A8, A9, A10, A11 Information processing apparatus
11, 211, 711 Acquisition unit
12, 212, 712, 1012 Determination unit
13, 213, 813, 913 Output unit
214 Image receiving unit
221, 421, 721, 821, 921, 1021, 1121 Management database
315, 515, 615, 715, 1115 Processing unit
316 External output unit
417, 717 Feature information identification unit
5151 Pattern generation unit
5152 Forming unit
5153 Color conversion unit
6154 Presentation unit
6155 Selection acquisition unit
622 Selection registration unit
1018 Receiving unit
1019 Selection unit

What is claimed is:

1. An information processing apparatus comprising:
at least one memory that is configured to store instructions; and
at least one processor that is configured to execute the instructions to:
acquire, from biometric information on a target included in an image, feature information indicating features of the biometric information;
determine whether or not unauthorized use of the biometric information is possible, by using the feature information; and
output an alert in response to the determination that the unauthorized use is possible.

2. The information processing apparatus according to claim 1, wherein the at least one processor is configured to execute the instructions to:
match the feature information acquired with registration feature information registered in advance; and
make the determination based on the matching result.

3. The information processing apparatus according to claim 1, wherein the at least one processor is configured to execute the instructions to output the alert to at least one of the target and a person who a person who makes the image processable in the information processing apparatus.

4. The information processing apparatus according to claim 1, wherein the at least one processor is configured to execute the instructions to process the image by adding processing information to an area corresponding to a feature area in the image in which the feature information is acquired.

5. The information processing apparatus according to claim 4, wherein the at least one processor is configured to execute the instructions to:
in a case of outputting the image to an outside of the information processing apparatus, process the image in response to the determination that the unauthorized use is possible; and
output the processed image to the outside of the information processing apparatus.

6. The information processing apparatus according to claim 1, wherein the at least one processor is configured to execute the instructions to:
perform face matching on the target included in the image;
identify the target;
identify registration feature information registered in association with the target;
match the feature information acquired with the registration feature information; and
make the determination based on the matching result.

7. The information processing apparatus according to claim 5, wherein
the at least one processor is configured to execute the instructions to process the image by adding,
to an area corresponding to an iris area including an iris of the target, serving as the feature area,
similar iris information similarity to the iris area, serving as the processing information.

8. The information processing apparatus according to claim 7, wherein the at least one processor is configured to execute the instructions to:
acquire a similar iris pattern;
generate a formed iris pattern in which a size of the similar iris pattern is formed to a size of the iris area;
convert a color of the formed iris pattern to a color similar to a color of the iris area;
generate the similar iris information; and
process the image by adding the similar iris information to the area corresponding to the iris area.

9. The information processing apparatus according to claim 4, wherein the at least one processor is configured to execute the instructions to:
present the target with a plurality of processing methods that are practicable; and
perform processing, by using a processing method selected by the target from among the plurality of processing methods during a predetermined period.

10. The information processing apparatus according to claim 5,
wherein the at least one memory that is configured to be registered feature information, the feature information including first feature information acquired by a first extraction engine that extracts feature information by using a first extraction method, and second feature information acquired by one or more second extraction engines, each of extracts feature information by using a different extraction method from the first extraction method; and the at least one processor is configured to execute the instructions to:
identify one or more pieces of registration feature information registered in association with the target included in the image, from the feature information registered in the at least one memory;
use the first extraction engine and the one or more second extraction engines;
match processed feature information acquired by from the image processed, with the one or more pieces of registration feature information; and
change a processing method, based on the matching result.

11. The information processing apparatus according to claim 10, wherein
the at least one processor is configured to execute the instructions to perform processing by using a processing method that satisfies at least one of:
a processing method that does not allow a success in matching using a matching engine with a highest processing capacity that is usable for determination; and
a processing method that does not allow a success in matching using all of matching engines that are usable for determination,
so as not to determine that the unauthorized use is possible, from a matching result between the processed feature information and the one or more pieces of registration feature information.

12. The information processing apparatus according to claim 1, wherein
information indicating whether or not processing is necessary for each type of biometric information, is registered for each user who uses a service provided by the information processing apparatus, and
the at least one processor is configured to execute the instructions not to output an alert, in response to the determination that the unauthorized use of the biometric information is possible, by using the feature information acquired from a type of biometric information that does not require processing.

13. The information processing apparatus according to claim 1, wherein
information indicating whether or not an output of an alert is necessary, is registered for each user who uses a service provided by the information processing apparatus, and
the at least one processor is configured to execute the instructions not to output an alert to the user for whom the output of an alert is unnecessary, even in a case of the determination that the biometric information on the target is usable for unauthorized purposes.

14. The information processing apparatus according to claim 5, wherein
information indicating whether or not an output of an alert is necessary, is registered for each user who uses a service provided by the information processing apparatus, and
in response to the determination that the biometric information on the target included in the image other than the user who does not require the output of an alert is usable for unauthorized purposes, at least one of the output of an alert and processing of the biometric information on the target, is performed.

15. The information processing apparatus according to claim 5, wherein the at least one processor is configured to execute the instructions to:
select all images including the target from among images stored in a database;
make the determination for all the selected images; and
process the image including the biometric information that is determined to be unusable for unauthorized purposes.

16. The information processing apparatus according to claim 5, wherein
a degree of processing is set for each user who uses a service provided by the information processing apparatus, and
the at least one processor is configured to execute the instructions to add processing information corresponding to the set degree, to the area corresponding to the feature area in the image.

17. The information processing apparatus according to claim 16, wherein the at least one processor is configured to execute the instructions to change the degree of processing, depending on a size of the feature area in the image.

18. The information processing apparatus according to claim 16, wherein
a target who is other than, but related to the user, is registered in association with the user, and
the degree of processing is set for each registered target.

19. An information processing method comprising:
acquiring, from biometric information on a target included in an image, feature information indicating features of the biometric information;
determining whether or not unauthorized use of the biometric information is possible, by using the feature information; and
outputting an alert in response to a determination that the unauthorized use is possible.

20. A non-transitory recording medium on which a computer program that allows a computer to execute an information processing method is recorded, the information processing method including:
acquiring, from biometric information on a target included in an image, feature information indicating features of the biometric information;
determining whether or not unauthorized use of the biometric information is possible, by using the feature information; and
outputting an alert in response to a determination that the unauthorized use is possible.
